(19) United States
(12) Patent Application Publication
(10) Pub. No.: US 2010/0329165 A1
(43) Pub. Date: Dec. 30, 2010

(54) WIRELESS LAN APPARATUS AND CONTROL METHOD THEREOF

(75) Inventor: Nagahiro MATSUURA, Ichinomiya-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Buffalo Inc., Nagoya (JP)

(21) Appl. No.: 12/786,897

(22) Filed: May 25, 2010

(30) Foreign Application Priority Data
May 25, 2009 (JP) P2009-125654

(51) Int. Cl. H04W 52/02; G08C 17/00

(52) U.S. Cl. 370/311

(57) ABSTRACT

A wireless LAN base station is operated with a battery or an AC adapter, and transmits and receives communication signals to and from another wireless LAN apparatus. The wireless LAN base station includes: PA and LNA configured to amplify the communication signals; selectors configured to select amplification routes through which the communication signals go through the amplifier, or bypass routes through which the communication signals bypass the amplifier; an AC/battery detecting circuit configured to detect a battery operation state where the wireless LAN base station is operated with the battery, and a AC operation state where the wireless LAN base station is operated with the AC adapter; and a CPU configured to have the amplification routes selected if the AC operation state is detected, and to have the bypass routes selected if the battery operation state is detected.

### CROSS REFERENCE TO RELATED APPLICATION

This application is based upon and claims the benefit of priority from the prior Japanese Patent Application No. 2009-125654 filed on May 25, 2009; the entire contents of which are incorporated herein by reference.

### BACKGROUND OF THE INVENTION

1. Field of the Invention

The present invention relates to a wireless LAN apparatus is that transmits and receives communication signals to and from another wireless LAN apparatus, and a control method thereof.

2. Description of the Related Art

There have heretofore been widely used local area network (LAN) systems in which communication signals are transmitted and received through wireless communications, i.e., wireless LAN systems. In such wireless LAN systems, most of wireless LAN base stations (wireless LAN apparatuses) to which wireless LAN terminals are connected are stationary, and are operated with external power supplies such as AC power supplies.

In recent years, portable wireless LAN base stations capable of battery-powered operation have been provided to improve convenience of wireless LAN systems. It is preferable that a wireless LAN apparatus operated with a battery should have battery life extended as long as possible by reducing power consumption.

The following method is proposed as a method for reducing power consumption of a wireless LAN apparatus (refer to Patent Literature 1: Japanese Patent No. 3875244). In the method disclosed in Patent Literature 1, a wireless LAN apparatus (a wireless LAN terminal such as a wireless LAN card) monitors a communication condition between itself and a wireless LAN base station. Then, the wireless LAN apparatus establishes a signal route in which communication signals bypass an amplifier when the communication condition is favorable, e.g., an error rate is low, whereas the wireless LAN apparatus establishes a signal route in which communication signals go through the amplifier when the communication condition is unfavorable.

### SUMMARY OF THE INVENTION

In the method disclosed in Patent Literature 1, regardless of whether or not the wireless LAN apparatus is operated with a battery, the signal route of the communication signals is controlled on the basis of a communication condition. Consequently, even when the wireless LAN apparatus is operated with a battery, the communication signals go through the amplifier in some cases. Since the amplifier consumes a large amount of power, this impedes sufficient extension of battery life of the wireless LAN apparatus.

The present invention provides: a wireless LAN apparatus capable of sufficiently extending battery life while being operated with a battery; and a control method thereof.

The present invention has the following aspects to solve the problems described above. First of all, a first aspect of the present invention is summarized as a wireless LAN apparatus (wireless LAN base station 1, for example) which is operated with any one of a battery (battery 41, for example) and an external power supply (AC adaptor 42, for example), and which transmits and receives communication signals to and from another wireless LAN apparatus (wireless LAN terminals 2 and 3, for example), comprising: an amplifier (PA 11 and LNA 21, for example) configured to amplify the communication signals; a route selector (selectors SL1, SL2, SL3 and SL4, for example) configured to select any one of a first signal route (amplification routes R1a and R2a, for example) through which the communication signals go through the amplifier, and a second signal route (bypass routes R1b and R2b, for example) through which the communication signals bypass the amplifier; an operation state detector (AC/battery detecting circuit 43, for example) configured to detect a battery operation state where the wireless LAN apparatus is operated with the battery, and an external power supply operation state where the wireless LAN apparatus is operated with the external power supply; and a controller (CPU 50, for example) configured to cause the route selector to select the first signal route if the external power supply operation state is detected by the operation state detector, and to cause the route selector to select the second signal route if the battery operation state is detected by the operation state detector.

Since a wireless LAN apparatus can be operated with a battery, i.e., a portable wireless LAN apparatus is used while being placed near another wireless LAN apparatus which is a communication target, the wireless LAN apparatus capable of performing communications without using an amplifier.

Consequently, a wireless LAN apparatus according to an aspect of the present invention causes a route selector to select a second signal route when a battery operation state is detected. This allows the wireless LAN apparatus to communicate with another wireless LAN apparatus and reduce power consumption. Thereby, the wireless LAN apparatus can extend battery life sufficiently.

Additionally, the wireless LAN apparatus according to an aspect of the present invention causes the route selector to select a first signal route when an external power supply operation state is detected. This allows the wireless LAN apparatus to secure a communication distance as long as in the case of a stationary wireless LAN apparatus.

A second aspect of the present invention is summarized as the wireless LAN apparatus according to the first aspect of the present invention, further comprising a switching unit (switches SW1 and SW2, for example) configured to switch whether to stop power supply to the amplifier or not, wherein the controller causes the switching unit to stop power supply to the amplifier, in a case where the battery operation state is detected by the operation state detector.

A third aspect of the present invention is summarized as the wireless LAN apparatus according to the second aspect of the present invention, wherein: the controller operates in any one of a first operating mode (normal mode, for example) and a second operating mode (on-keeping mode, for example); the first mode is an operating mode in which the controller adaptively controls the route selector and the switching unit; and the second mode is an operating mode in which the route selector is kept selecting the first signal route while the switching unit is kept in a state of supplying power to the amplifier.

A fourth aspect of the present invention is summarized as the wireless LAN apparatus according to the third aspect of the present invention, further comprising an operation accepting unit (manual switch 80, for example) configured to accept an operation of selecting any one of the first operating mode and the second operating mode from a user, wherein the controller operates in the first operating mode when the operation accepting unit accepts the operation of selecting the first operating mode, while the controller operates in the second operating mode when the operation accepting unit accepts the operation of selecting the second operating mode.

A fifth aspect of the present invention is summarized as the wireless LAN apparatus according to the first aspect of the present invention, wherein the amplifier is at least any one of is a power amplifier (PA 11, for example) and a low noise amplifier (LNA 21, for example) that amplify the communication signals of a radio frequency band.

A sixth aspect of the present invention is summarized as a control method of a wireless LAN apparatus which is operated with any one of a battery and an external power supply, and which transmits and receives communication signals to and from another wireless LAN apparatus, comprising the steps of: determining whether the wireless LAN apparatus is operated with the external power supply, or the wireless LAN apparatus is operated with the battery; selecting a first signal route through which the communication signals go through an amplifier provided in the wireless LAN apparatus, in a case where the wireless LAN apparatus is determined to be operated with the external power supply in the step of determining; and selecting a second signal route through which the communication signals bypass the amplifier, in a case where the wireless LAN apparatus is determined to be operated with the battery in the step of determining.

A seventh aspect of the present invention is summarized as the control method according to the sixth aspect of the present invention, further comprising the step of stopping power supply to the amplifier, in a case where the wireless LAN apparatus is determined to be operated with the battery in the step of determining.

A eighth aspect of the present invention is summarized as the control method according to the seventh aspect of the present invention, further comprising the step of keeping the first signal route being selected while keeping power being supplied to the amplifier, in a case where a predetermined operating mode is designated by an operation of a user.

A ninth aspect of the present invention is summarized as the control method according to the sixth aspect of the present invention, wherein the amplifier is at least any one of a power amplifier and a low noise amplifier that amplify the communication signals of a radio frequency band.

### BRIEF DESCRIPTION OF THE DRAWINGS

FIG. 1 is an entire schematic configuration diagram of a wireless LAN system including a wireless LAN base station according to an embodiment of the present invention.

FIG. 2 is a block diagram showing the wireless LAN base station according to the embodiment of the present invention.

FIG. 3 is a circuit diagram showing a configuration example of an AC/battery detecting circuit according to the embodiment of the present invention.

FIG. 4 is a flowchart showing a control flow according to the embodiment of the present invention.

### DESCRIPTION OF EMBODIMENTS

Next, a wireless LAN base station, which is an embodiment of a wireless LAN apparatus of the present invention, is described with reference to the drawings. Specifically, (1) an entire schematic configuration of a wireless LAN system, (2) a configuration of the wireless LAN base station, (3) a control flow, (4) effects of the embodiment, and (5) other embodiments are described.

In the following description of the drawings in the embodiments, same or similar reference numerals are used for same or similar parts.

### 1 Entire Schematic Configuration of Wireless LAN System

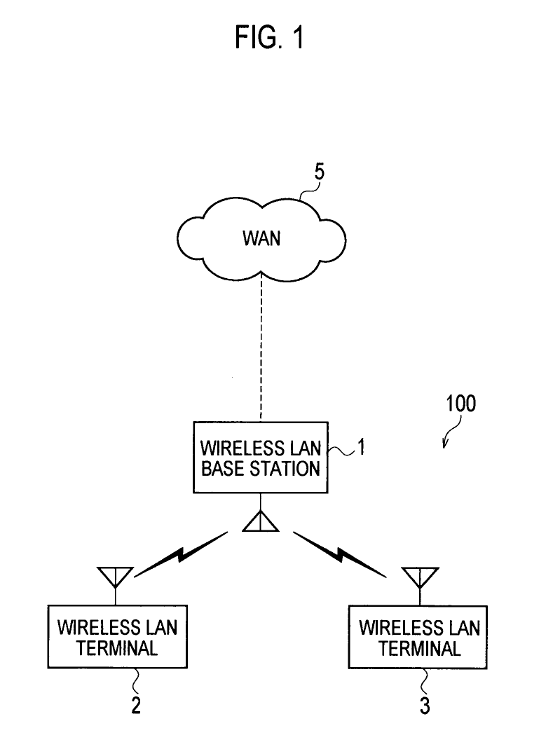

FIG. 1 is an entire schematic configuration diagram of a wireless LAN system 100 including a wireless LAN base station 1 which is an embodiment of the wireless LAN apparatus of the present invention. In the wireless LAN system 100, wireless communications based on wireless LAN standards such as IEEE 802 0.11a/b/g/n are performed, for example.

A wireless LAN terminal 2 and a wireless LAN terminal 3 are wirelessly connected to the wireless LAN base station 1. Although FIG. 1 shows an example where two wireless LAN terminals are connected wirelessly to the wireless LAN base station 1, only one wireless LAN terminal or three or more wireless LAN terminals may be connected thereto.

The wireless LAN base station 1 is, for example, a portable wireless LAN access point, a portable wireless LAN router, or the like. Each of the wireless LAN terminal 2 and wireless LAN terminal 3 is, for example, a wireless LAN card, an USB wireless LAN adapter, a wireless LAN-equipped game machine, a wireless LAN-equipped notebook PC, a wireless LAN-equipped mobile phone, or the like.

The wireless LAN base station 1 is connected to a wide area network (WAN) 4. The form of connection between the wireless LAN base station 1 and the WAN 4 may be wired or wireless. In this embodiment, the wireless LAN base station 1 is wirelessly connectable to the WAN 4 by the utilization of a personal handyphone system (PHS) or like.

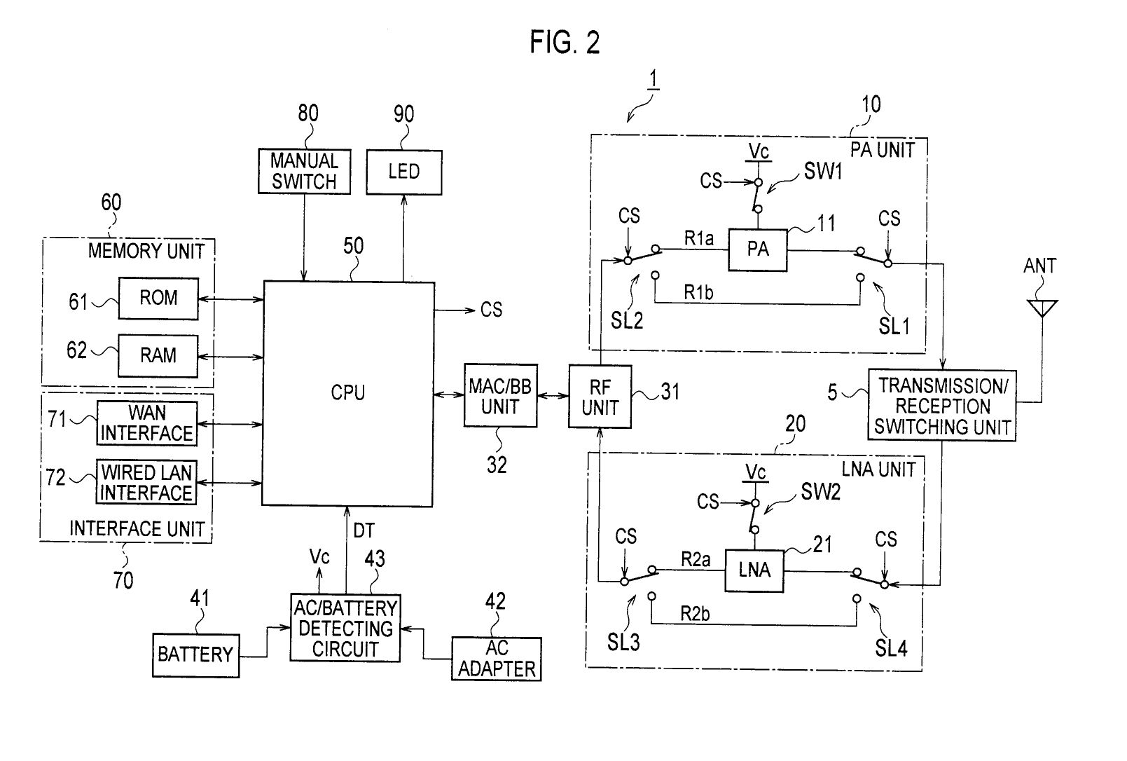

The wireless LAN base station 1 is configured to be operable with either a battery 41 or an AC adapter 42 (external power supply) (refer to FIG. 2). More specifically, when being used indoors such as at home or in the workplace, the wireless LAN base station 1 is operated with the AC adapter 42, thereby functioning like a stationary wireless LAN base station. On the other hand, when being carried to and used at an outside location or the like, the wireless LAN base station 1 is operated with the battery 41 instead of being operated with the AC adapter 42.

In cases where the wireless LAN base station 1 is used at an outside location or the like, the wireless LAN base station 1 is used in the following manner. For example, in a case where a user plays an online game or the like with a wireless LAN-equipped game machine (wireless LAN terminal), the wireless LAN base station 1 is used while being placed near a user operating the wireless LAN-equipped game machine.

In such cases, power is wastefully consumed by the wireless LAN base station 1 for securing a communication distance. For this reason, in this embodiment, the function of securing a communication distance is stopped under the condition that the wireless LAN base station 1 is used at an outside location or the like (more specifically, under the condition that the wireless LAN base station 1 is operated with the battery 41). Thereby, wasteful power consumption is reduced, and battery life is extended.

### 2 Configuration of Wireless LAN Base Station

Next, a configuration of the wireless LAN base station 1 is described in the order of (2.1) a schematic configuration of the wireless LAN base station, (2.2) configurations of a PA unit and an LNA unit, and (2.3) a configurations of an AC/battery detecting circuit.

### 2.1 Schematic Configuration of Wireless LAN Base Station

FIG. 2 is a block diagram showing the wireless LAN base station 1.

As shown in FIG. 2, the wireless LAN base station 1 transmits and receives radio-frequency (RF) communication signals to and from the wireless LAN terminals 2 and 3 via an antenna ANT.

The wireless LAN base station 1 includes a power amplifier (PA) unit 10 and a low noise amplifier (LNA) unit 20. The PA unit 10 includes a PA 11 configured to amplify RF transmission signals. The LNA unit 20 includes an LNA 21 configured to amplify RF reception signals.

The PA unit 10 and the LNA unit 20 are connected to the antenna ANT via a transmission/reception switching unit 5. The PA unit 10 and the LNA unit 20 are also connected to an RF unit 31 configured to process the RF communication signals. The RF unit 31 includes a mixer, a filter and the like. Here, the mixer is provided for up-conversion and down-conversion of communication signals, while the filter is provided for eliminating noise elements.

An MAC/BB unit 32 that processes baseband (BB) communication signals is connected to the RF unit 31 and a CPU 50 so as to intermediate therebetween. The MAC/BB unit 32 performs modulation and demodulation of communication signals, encoding and decoding thereof, and the like.

The CPU 50 constitutes a controller that controls various functions included in the wireless LAN base station 1. A memory unit 60 stores therein various information and programs used for control and the like performed by the CPU 50. The memory unit 60 includes a ROM 61 and a RAM 62. The ROM 61 stores therein a program executed by the CPU 50, and the like. The RAM 62 functions as a work region for the CPU 50. An LED 90, which is used for notifying a user of an operating state of the wireless LAN base station 1, is connected to the CPU 50.

An interface unit 70 configured to function as an interface to networks other than a wireless LAN is also connected to the CPU 50. In this embodiment, the interface unit 70 includes a WAN interface 71 connected to the WAN 4, and a wired LAN interface 72 connected to a wired LAN.

An AC/battery detecting circuit 43, and a manual switch 80 (operation accepting unit) are connected to the CPU 50. The AC/battery detecting circuit 43 detects a battery operation state where the wireless LAN base station 1 is operated with the battery 41, and an AC operation state (external power supply operation state) where the wireless LAN base station 1 is operated with the AC adapter 42. In this embodiment, the AC/battery detecting circuit 43 constitutes an operation state detector.

The manual switch 80 is used for switching between operating modes of the wireless LAN base station 1. In this embodiment, a normal mode (first operating mode) and an on-keeping mode (second operating mode) are provided as the operating modes. The manual switch 80 accepts an operation of selecting the normal mode or the on-keeping mode from a user. Then, the CPU 50 operates in the normal mode or the on-keeping mode in accordance with a content of the above operation. Details of the normal mode and the on-keeping mode are described later.

### 2.2 Configurations of PA Unit and LNA Unit

Next, the configurations of the PA unit 10 and the LNA unit 20 are described.

In the PA unit 10, two signal routes are provided which are an amplification route R1a (first signal route), and a bypass route R1b (second signal route). The PA 11 is connected onto the amplification route R1a. The amplification route R1a is a signal route through which a transmission signal goes through the PA 11. The bypass route R1b is a signal route through which a transmission signal bypasses the PA 11.

A selector SL1 is connected to one end of the amplification route R1a and the bypass route R1b, and a selector SL2 is connected to the other end thereof. The selectors SL1 and SL2 select the amplification route R1a or the bypass route R1b under the control of the CPU 50. In the example in FIG. 2, the selectors SL1 and SL2 select the amplification route R1a. In this embodiment, the selectors SL1 and SL2 constitute a route selector configured to select the amplification route R1a or the bypass route R1b.

The PA unit 10 includes a switch SW1 (switching unit). Under the control of the CPU 50, the switch SW1 switches whether to stop power supply to the PA 11 or not.

The selector SL1, the selector SL2 and the switch SW1 operate in compliance with a control signal CS outputted from the CPU 50. For example, the switch SW1 is configured to stop power supply to the PA 11 when the control signal CS is at a low level, and to supply power to the PA 11 when the control signal CS is at a high level. The selector SL1 and the selector SL2 are configured to select the bypass route R1b when the control signal CS is at the low level, and to select the amplification route R1a when the control signal CS is at the high level.

Like the PA unit 10, the LNA unit 20 has two signal routes provided therein which are an amplification route R2a (first signal route), and a bypass route R2b (second signal route). The LNA 21 is connected onto the amplification route R2a. The amplification route R1a is a signal route through which a reception signal goes through the LNA 21. The bypass route R2b is a signal route through which a reception signal bypasses the LNA 21.

A selector SL3 is connected to one end of the amplification route R2a and the bypass route R2b, and a selector SL4 is connected to the other end thereof. The selectors SL3 and SL4 select the amplification route R2a or the bypass route R2b under the control of the CPU 50. In the example in FIG. 2, the selectors SL3 and SL4 select the amplification route R2a. In this embodiment, the selectors SL3 and SL4 constitute a route selector configured to select the amplification route R2a or the bypass route R2b.

The LNA unit 20 includes a switch SW2 (a switching unit). Under the control of the CPU 50, the switch SW2 switches whether to stop power supply to the LNA 21 or not.

The selector SL3, the selector SL4 and the switch SW2 operate in compliance with the control signal CS outputted from the CPU 50. For example, the switch SW2 is configured to stop power supply to the LNA 21 when the control signal CS is at the low level, and to supply power to the LNA 21 when the control signal CS is at the high level. The selector SL3 and the selector SL4 are configured to select the bypass route R2b when the control signal CS is at the low level, and to select the amplification route R2a when the control signal CS is at the high level.

### 2.3 Configuration of AC/Battery Detecting Circuit

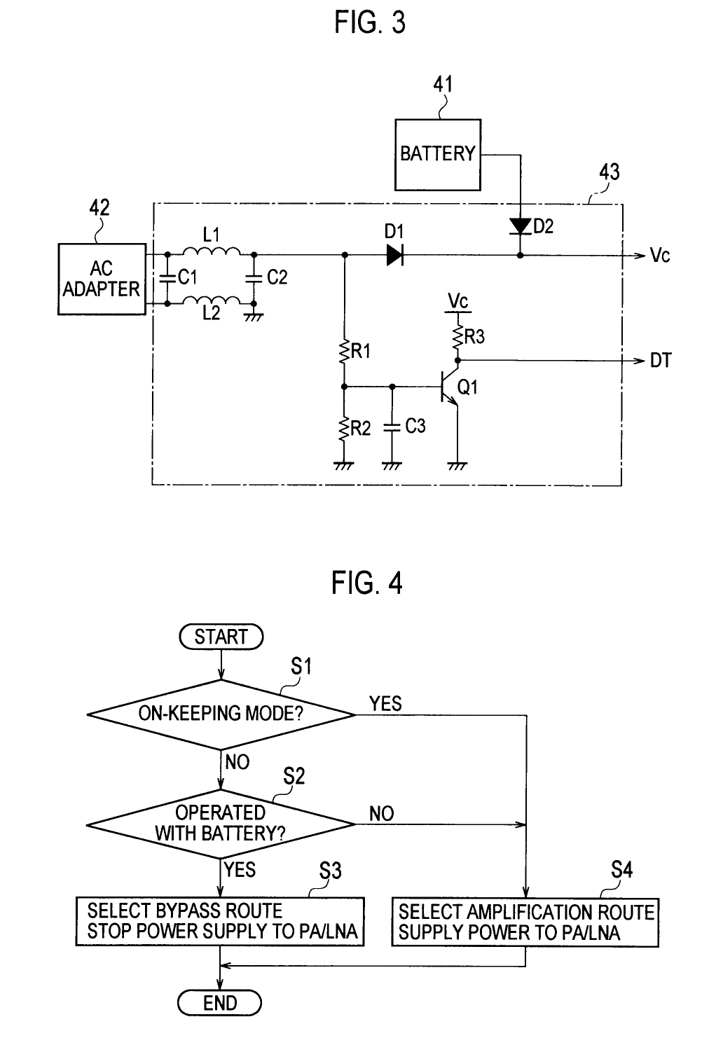

FIG. 3 is a circuit diagram showing a configuration example of the AC/battery detecting circuit 43.

As shown in FIG. 3, the AC/battery detecting circuit 43 includes capacitors C1, C2 and C3, coils L1 and L2, diodes D1 and D2, resistances R1, R2 and R3, and a transistor Q1.

When a voltage occurs at the AC adapter input, a voltage outputted from a rectification circuit composed of the capacitors C1, C2 and the coils L1, L2 is divided through a voltage dividing circuit composed of the resistances R1 and R2, and then turns on the transistor Q1. In a state where the transistor Q1 is on, a detection signal DT then being at a low level is outputted from a collector terminal of the transistor Q1.

When there is no voltage occurring at the input of the AC adapter, the transistor Q1 is turned off, and the detection signal DT then being at a high level is outputted from the collector terminal of the transistor Q1.

The detection signal DT is inputted to the CPU 50. As a result, the CPU 50 recognizes the AC operation state when the detection signal DT being at the low level is inputted thereto, and recognizes the battery operation state when the detection signal DT being at the high level is inputted thereto.

### 3 Control Flow

FIG. 4 is a flowchart showing a control flow executed by the CPU 50. Note that the control flow in FIG. 4 may be executed only at an initial stage of operation of the CPU 50, or may be repeatedly executed at predetermined time intervals. The control flow in FIG. 4 is not limited to being executed only at the initial stage of the operation, and being repeatedly executed at predetermined time intervals, and may be executed when an external trigger occurs.

In step S1, the CPU 50 determines whether a current operation mode of the CPU 50 is the normal mode or the on-keeping mode. If the current operating mode is the on-keeping mode, processing goes to step S4. If the current operating mode is the normal mode, the processing goes to step S2.

Here, the on-keeping mode is a mode in which the PA 11 and LNA 21 are forcibly used. In the on-keeping mode, the CPU 50 keeps the control signal CS at the high level. Thereby, the selectors SL1 and SL2 are kept selecting the amplification route R1a, and the switch SW1 is kept in a state of supplying power to the PA 11. Otherwise, the selectors SL3 and SL4 are kept selecting the amplification route R2a, and the switch SW2 is kept in a state of supplying power to the LNA 21.

The normal mode is a mode in which extension of battery life is given priority, whereas the on-keeping mode is a mode in which a communication distance is given priority. In the normal mode, the CPU 50 adaptively controls the selectors SL1, SL2, SL3, SL4 and the switches SW1, SW2 by using the control signal CS.

In step S2, on the basis of the detection signal DT outputted from the AC/battery detecting circuit 43, the CPU 50 determines whether the wireless LAN base station 1 is in the AC operation state or in the battery operation state. If the wireless LAN base station 1 is in the battery operation state, the processing goes to step S3. On the other hand, if the wireless LAN base station 1 is in the AC operation state, the processing goes to step S4.

In step S3, the CPU 50 sets the control signal CS at the low level. Thereby, the CPU 50 causes the selectors SL1 and SL2 to select the bypass route R1b, and causes the switch SW1 to stop power supply to the PA 11. Otherwise, the CPU 50 causes the selectors SL3 and SL4 to select the bypass route R2b, and causes the switch SW2 to stop power supply to the LNA 21.

In step S4, the CPU 50 sets the control signal CS at the high level. Thereby, the CPU 50 causes the selectors SL1 and SL2 to select the amplification route R1a, and causes the switch SW2 to supply power to the PA 11. Otherwise, the CPU 50 causes the selectors SL3 and SL4 to select the amplification route R2a, and causes the switch SW2 to supply power to the LNA 21.

Note that the order of steps S1 and S2 may be reversed. Further, it is preferable that, when the manual switch 80 accepts an operation of a user apart from the control flow shown in FIG. 4, the CPU 50 should immediately switch between the operating modes in accordance with an instruction of the operation.

### 4 Effects of Embodiment

As described above, the CPU 50 causes the selectors SL1, SL2, SL3 and SL4 to select the bypass routes R1b and R2b, thereby being capable of reducing power consumption in the battery operation state. Furthermore, since the CPU 50 stops power supply to the PA 11 and LNA 21 in the battery operation state, the CPU 50 is capable of greatly reducing power consumption, and thereby enables extended battery life sufficiently.

Moreover, the CPU 50 causes the selectors SL1, SL2, SL3 and SL4 to select the amplification routes R1a and R2a in the AC operation state, thereby being capable of securing a sufficient communication distance as in the case of a stationary wireless LAN base station.

In this embodiment, the CPU 50 operates in the on-keeping mode when the manual switch 80 accepts an operation of selecting the on-keeping mode from a user. Therefore, even in the battery operation state, more specifically, even in a case where the wireless LAN base station 1 is carried to and used at an outside location or the like, the PA 11 and the LNA 21 can be used as desired by the user when a need to secure a sufficient communication distance occurs.

### 5 Other Embodiments

Although the present invention is described as above by way of an embodiment, the statements and the drawings each constituting a part of this disclosure should not be understood as limiting the present invention. From this disclosure, various alternative embodiments, examples and operational techniques are apparent to those skilled in the art.

For example, the above described embodiment is described by citing the wireless LAN system 100 based on IEEE 802.11a/b/g/n. However, the wireless LAN standards are not limited to IEEE 802.11a/b/g/n, and other wireless LAN standards are alternatively usable. Further, although a wireless LAN base station is described as an embodiment of the wireless LAN apparatus of the present invention, the present invention may be applied to a wireless LAN terminal.

In the above described embodiment, bypass routes are provided to the PA unit 10 and the LNA unit 20, respectively. However, a configuration in which a bypass route is provided only in the PA unit 10 may be employed alternatively since the PA 11 is a part consuming the largest power in the wireless LAN base station 1. Further, in a case where there is an amplifier inside the RF unit 31, and a case where there is an amplifier for amplifying intermediate-frequency (IF) communication signals, routes bypassing these amplifiers may be provided.

In the above described embodiment, a configuration is described where the manual switch 80 is connected to the CPU 50 by the utilization of GPIO (General Purpose Input/Output) or the like. However, another configuration may be alternatively employed where the manual switch 80 is connected to the AC/battery detecting circuit 43. For example, the same control over the operating modes as in the above described embodiment can be performed by using the manual switch 80 in order to forcibly keep the detection signal DT outputted by the AC/battery detecting circuit 43 at the low level.

Additionally, although the manual switch 80 is used as the operation accepting unit in the above described embodiment, the operation accepting unit is not limited to the manual switch 80, and has only to be capable of accepting an operation from a user. For example, a push button or a touch panel may be alternatively used as the operation accepting unit. Furthermore, another configuration may be alternatively employed where control over the operating modes is performed indirectly. Specifically, the operation accepting unit used for control over the operating modes can be omitted by making control over the operating modes settable through the Web,

It should be understood that the present invention include various embodiments not described herein. Accordingly, the present invention shall be limited only by invention-specifying matters included in the scope of claims, which are appropriate from this disclosure.

What is claimed is:

1. A wireless LAN apparatus which is operated with any one of a battery and an external power supply, and which transmits and receives communication signals to and from another wireless LAN apparatus, comprising:
an amplifier configured to amplify the communication signals;
a route selector configured to select any one of a first signal route through which the communication signals go through the amplifier, and a second signal route through which the communication signals bypass the amplifier;
an operation state detector configured to detect a battery operation state where the wireless LAN apparatus is operated with the battery, and an external power supply operation state where the wireless LAN apparatus is operated with the external power supply; and
a controller configured to cause the route selector to select the first signal route if the external power supply operation state is detected by the operation state detector, and to cause the route selector to select the second signal route if the battery operation state is detected by the operation state detector.

2. The wireless LAN apparatus according to claim 1, further comprising a switching unit configured to switch whether to stop power supply to the amplifier or not, wherein
the controller causes the switching unit to stop power supply to the amplifier, in a case where the battery operation state is detected by the operation state detector.

3. The wireless LAN apparatus according to claim 2, wherein:
the controller operates in any one of a first operating mode and a second operating mode;
the first mode is an operating mode in which the controller adaptively controls the route selector and the switching unit; and
the second mode is an operating mode in which the route selector is kept selecting the first signal route while the switching unit is kept in a state of supplying power to the amplifier.

4. The wireless LAN apparatus according to claim 3, further comprising an operation accepting unit configured to accept an operation of selecting any one of the first operating mode and the second operating mode from a user, wherein
the controller operates in the first operating mode when the operation accepting unit accepts the operation of selecting the first operating mode, while the controller operates in the second operating mode when the operation accepting unit accepts the operation of selecting the second operating mode.

5. The wireless LAN apparatus according to claim 1, wherein
the amplifier is at least any one of a power amplifier and a low noise amplifier that amplify the communication signals of a radio frequency band.

6. A control method of a wireless LAN apparatus which is operated with any one of a battery and an external power supply, and which transmits and receives communication signals to and from another wireless LAN apparatus, comprising the steps of:
determining whether the wireless LAN apparatus is operated with the external power supply, or the wireless LAN apparatus is operated with the battery;
selecting a first signal route through which the communication signals go through an amplifier provided in the wireless LAN apparatus, in a case where the wireless LAN apparatus is determined to be operated with the external power supply in the step of determining; and
selecting a second signal route through which the communication signals bypass the amplifier, in a case where the wireless LAN apparatus is determined to be operated with the battery in the step of determining.

7. The control method according to claim 6, further comprising the step of stopping power supply to the amplifier, in a case where the wireless LAN apparatus is determined to be operated with the battery in the step of determining.

8. The control method according to claim 7, further comprising the step of keeping the first signal route being selected while keeping power being supplied to the amplifier, in a case where a predetermined operating mode is designated by an operation of a user.

9. The control method according to claim 6, wherein
the amplifier is at least any one of a power amplifier and a low noise amplifier that amplify the communication signals of a radio frequency band.
